(19) United States
(12) Patent Application Publication
(10) Pub. No.: US 2026/0154950 A1
(43) Pub. Date: Jun. 4, 2026

(54) METHOD FOR CREATING GENERATIVE TIME SERIES DATASET FOR CHANGE DETECTION IN REMOTE SENSING

(71) Applicant: ELM, Riyadh (SA)

(72) Inventors: Faroq AL TAM, Riyadh (SA); Abdulmalik ALDAWSARI, Riyadh (SA); Thariq KHALID, Riyadh (SA); Muhammad ALQURISHI, Riyadh (SA); Riad SOUISSI, Riyadh (SA)

(73) Assignee: ELM, Riyadh (SA)

(21) Appl. No.: 19/406,336

(22) Filed: Dec. 2, 2025

Related U.S. Application Data
(60) Provisional application No. 63/727,048, filed on Dec. 2, 2024.

(51) Int. Cl. G06V 10/776; G06T 5/77; G06T 7/50; G06V 10/82; G06V 20/13; G06V 20/17; G06V 20/70

(52) U.S. Cl. CPC G06V 10/776; G06T 5/77; G06T 7/50; G06V 10/82; G06V 20/13; G06V 20/17; G06V 20/70

(57) ABSTRACT

A system, method and non-transitory computer readable medium for generating validated remote sensing change images that includes a user input device for selecting high-resolution satellite images, and processing circuitry to generate a depth map and a semantic map from a static image. A change simulator determines candidate areas for change simulation and generates a change depth map and change mask focusing on objects removed from the static image. An image diffusion neural network applies a control network and stable diffusion to generate pre-change and post-change image tiles. Validation processing circuitry iterates through a validation process to validate the pair of change tiles to obtain a validated pair of change tiles and a validated change mask.

### CROSS-REFERENCE TO RELATED APPLICATIONS

This application claims the benefit of priority to provisional application no. 63/727,048 filed Dec. 2, 2024, the entire contents of which are incorporated herein by reference.

### BACKGROUND

### Technical Field

The present disclosure is directed to remote sensing and geospatial analysis, and more particularly to techniques for monitoring and detecting changes in land use, land cover, and environmental conditions over time using satellite imagery and artificial intelligence based processing.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Remote sensing has become an important tool for large scale environmental and urban monitoring. Remote sensing involves capturing images by satellites, aerial photography, and unmanned aerial vehicles. The images range in resolution. Satellite imaging produces a wide range of resolutions, from very high resolution, about 30 cm/pixel, to low resolution, several hundred m/pixel. Aerial imaging produces images of about 5 cm/pixel to 30 cm/pixel. Unmanned aerial vehicles can provide the highest resolution, on the order of sub-centimeter to 15 cm/pixel. However, remote images of any particular area are sparse, and subject to imperfections, such as variations due to weather conditions. Moreso, remote images of change in particular areas over time are extremely sparse.

Modern cities, large scale mining operations, and technology driven agriculture are expanding at an unprecedented pace. Governments, municipalities, and regulatory authorities are increasingly required to monitor changes across very large territories in order to manage infrastructure, enforce zoning regulations, and protect natural resources. For example, rapid urban expansion may encroach on agricultural land, while unregulated mining may alter landscapes and affect nearby communities. In parallel, contemporary urban planning emphasizes the design and maintenance of green spaces, such as parks, conservation areas, and urban forests, as an essential component of self sustainability indices and quality of life metrics. The disappearance of such green spaces, coupled with an increase in construction activities, is one of the significant concerns associated with climate change and environmental degradation.

Many remote sensing applications, such as urban development analysis or deforestation tracking, rely on a solid archive of change timelines that describe how a particular region has evolved over months or years. In a typical change detection workflow, a reference image acquired before a change event is compared with a future image acquired after the change for the same geographic area. By comparing the pre change and post change satellite images, analysts attempt to determine where and how the terrain, vegetation, or built environment has changed.

Change detection is used to detect change in particular areas over time. Artificial intelligence based methods have been applied to automate change detection and to improve the accuracy and scalability of such analyses. However, solving change detection using artificial intelligence is challenging due to several factors. Satellite imagery often exhibits imaging imperfections arising from sensor noise, varying viewing angles, atmospheric effects, and differences in illumination conditions between acquisition dates. In addition, there is often a lack of remote images for use as training data that accurately represent the diversity of real world change scenarios. Changes can also be seasonal in nature, such as variations in vegetation cover between summer and winter, or changes in water bodies due to rainfall patterns. These seasonal changes must be ignored when they are merely the result of weather conditions or seasons rather than structural or man made modifications, which further complicates automated change detection.

Obtaining comprehensive satellite data at appropriate spatial and temporal resolutions is expensive and logistically difficult. There may be gaps in imagery records for certain regions or time periods due to limitations in satellite coverage, cloud cover, or acquisition schedules. Curating complete and consistent datasets under these constraints is therefore a nontrivial task. Furthermore, labeling change detection datasets is expensive and laborious because human experts must carefully annotate which regions of an image have changed, and in what manner, across multiple time points. These labeling efforts must often distinguish between meaningful structural changes and incidental variations caused by imaging conditions or seasonal effects.

To address the scarcity of labeled data, one line of research has explored simulating change using generative artificial intelligence. Generative models can, in principle, provide a broad and customizable change detection dataset by creating synthetic examples of how a scene might evolve over time. Earlier efforts in this research direction can be broadly divided into two main groups. A first group focuses on generating a single image from a semantic map or on editing an existing image. For example, given a high level map that specifies roads, buildings, and vegetation, a generative model can synthesize a corresponding satellite like image at typical satellite image resolutions, or modify certain regions of an image according to user instructions. Although such approaches can create visually plausible scenes, they often lack precise control over the resulting simulated changes. Unwanted or unintended changes, especially hallucinations that are irrelevant, made up, or inconsistent with the input data. may appear in the generated images, which reduces usefulness of simulated changes for training change detection models that need accurate and localized change annotations.

A second group of approaches focuses on building satellite imaging simulators that generate scenes from user defined settings, such as orbital parameters, sensor characteristics, atmospheric conditions, and land surface properties. These simulators attempt to mimic the physical imaging process of satellite sensors and can in theory produce diverse image sequences for different configurations. However, using simulated satellite imagery typically requires fine grained settings that may be difficult for practitioners to specify correctly. Even with detailed configuration, the generated imagery does not always lead to the desired or required results for change detection training, especially when the goal is to replicate complex real world development patterns or environmental changes.

Another important limitation of conventional generative and simulation based approaches is their inability to produce progressive changes that evolve in stages over time. Many practical monitoring tasks, such as tracking the gradual disappearance of green spaces, the multi phase expansion of a construction site, or the stepwise growth of a mining operation, require a sequence of intermediate change states rather than a simple before and after representation. Conventional methods that either generate isolated images or rely on static simulator configurations are typically not designed to generate such progressive change sequences in a controlled and realistic manner.

Accordingly, there remains a need for techniques in the field of remote sensing change detection that provide controllable and realistic simulation of changes, that can generate broad and customizable datasets without exhaustive manual labeling, that do not rely on overly fine grained simulator settings, and that are capable of representing progressive changes over time while being robust to imaging imperfections, data gaps, and seasonal variability.

An object is a system and method that generates change tiles from a single RGB. A further object is a system with a change selector that selects candidates for change, and a tile image generator that converts the output of the change selector into change tiles and a mask. To generate the change tiles, original and change depth maps are fed to a Stable Diffusion (SD) pipeline. A further object is an input for a desired number of time steps and generate progressive change tiles for the number of time steps. The generated change tiles and the associated change mask are then stored in a change detection dataset. A further aspect is a pipeline that assesses each object in the generated tiles.

### SUMMARY

In an exemplary embodiment, a computer-based artificial intelligence (AI) workstation is provided. The computer-based artificial intelligence (AI) workstation comprises a user input device for downloading aerial and Earth satellite images of high resolution or greater and selecting a static image from among the aerial and Earth satellite images, wherein the high resolution or greater is a pixel size of 0.3 m/pixel or less. The computer-based artificial intelligence (AI) workstation further comprises processing circuitry, comprising a plurality of multi-core processors for cyclically performing fused multiply-add (FMA) operations, configured to generate, by a depth map generation neural network, an original depth map of the static image, where the depth map is an image that contains information relating to distance of surfaces of objects from a viewpoint, create, by a semantic map creator, a semantic map of the static image, wherein the semantic map includes annotated objects in the static image, generate, by a change simulator that iteratively determines a plurality of candidate areas for change simulation, a change depth map and a change mask, wherein the change mask focuses on one or more objects removed from the static image, and generate, by an image diffusion neural network, a pair of change tiles and a mask using the change depth map, wherein the pair of change tiles includes a post-change tile and a pre-change tile. The computer-based artificial intelligence (AI) workstation further comprises a display device to display the pair of change tiles and the change mask and validate the pair of change tiles to obtain a validated pair of change tiles and a validated change mask, wherein when the pair of change tiles are found invalid, store an identifier for an invalid pair of change tiles in a rejected list. The computer-based artificial intelligence (AI) workstation further comprises a database configured to store the validated pair of change tiles and the validated mask.

In another exemplary embodiment, a method of remote image change detection is described. The method of remote image change detection comprises downloading, by a user input device, aerial and Earth satellite images of high resolution or greater, wherein the high resolution or greater is a pixel size of 0.3 m/pixel or less, and selecting, by the user input device, a static image from among the aerial and satellite images. The method further comprises generating, by multi-core processors that cyclically perform fused multiply-add operations for a depth map generator, an original depth map of the static image, where the depth map is an image that contains information relating to distance of surfaces of objects from a viewpoint, and creating, by processing circuitry configured with a semantic map creator, a semantic map of the static image, wherein the semantic map includes annotated objects in the static image. The method further comprises generating, by the processing circuitry configured with a change simulator that iteratively determines a candidate area for change simulation, a change depth map and a change mask, wherein the change mask focuses on one or more objects removed from the static image, and generating, by multi-core processors that cyclically perform fused multiply-add operations for a tile image generator, a pair of change tiles and a mask using the change depth map, wherein the pair of change tiles includes a post-change tile and a pre-change tile. The method further comprises storing the pair of change tiles and the mask in a database managing a plurality of pairs of change tiles and masks, and training, by the multi-core processors, a change detection model with the database of the plurality of pairs of change tiles and masks.

In yet another exemplary embodiment, a non-transitory computer-readable storage medium including computer executable instructions is described, wherein the instructions, when executed by an AI workstation, cause the computer to perform a method for generating a land use area change detection dataset. The method comprises downloading, by a user input device, aerial and Earth satellite images of high resolution or greater, wherein the high resolution or greater is a pixel size of 0.3 m/pixel or less, and selecting, by the user input device, a static image from among the aerial and satellite images. The method further comprises generating, by multi-core processors that cyclically perform fused multiply-add operations for a depth map generator, an original depth map of the static image, where the depth map is an image that contains information relating to distance of surfaces of objects from a viewpoint, and creating, by processing circuitry configured with a semantic map creator, a semantic map of the static image, wherein the semantic map includes annotated objects in the static image. The method further comprises generating, by the processing circuitry configured with a change simulator that iteratively determines a candidate area for change simulation, a change depth map and a change mask, wherein the change mask focuses on one or more objects removed from the static image, and generating, by multi-core processors that cyclically perform fused multiply-add operations for a tile image generator, a pair of change tiles and a mask using the change depth map, wherein the pair of change tiles includes a post-change tile and a pre-change tile. The method further comprises displaying, by a display device, the pair of change tiles and the mask and validating the pair of change tiles to obtain a validated pair of change tiles and a validated mask, wherein when the pair of change tiles are found invalid, storing an identifier for the pair of change tiles in a rejected list, and storing the validated pair of change tiles and the validated mask in a database.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a block diagram of a computer based artificial intelligence workstation, in accordance with some embodiments.

FIG. 2 is a block diagram of a processing pipeline for converting a single static RGB image into a pair of change tiles and an associated change mask using a depth map generation neural network, a semantic map creator, a change simulator, and an image diffusion neural network, according to certain embodiments.

FIG. 3 is a flowchart of a change simulator process for generating a change depth map and a change mask, according to certain embodiments.

FIG. 4 is a flowchart of a change validation unit configured to validate generated change tiles and change masks, according to certain embodiments.

FIG. 5 is a set of visual inspection results illustrating example depth maps, corresponding generated change tiles, and associated change masks produced by the processing pipeline, in accordance with some embodiments.

FIG. 6 is a set of visual inspection results illustrating progressive change generation in which successive depth maps, generated change tiles, and change masks depict object level evolution without modifying a surrounding scene, in accordance with some embodiments.

FIG. 7 illustrates an example hardware architecture of a computer-based artificial intelligence (AI) workstation, according to certain embodiments.

FIG. 8 is an illustration of a non-limiting example of details of computing hardware used in the computing system, according to certain embodiments.

FIG. 9 is an exemplary schematic diagram of a data processing system used within the computing system, according to certain embodiments.

FIG. 10 is an exemplary schematic diagram of a processor used with the computing system, according to certain embodiments.

FIG. 11 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a computer-based artificial intelligence (AI) workstation, a method of remote image change detection, and a non-transitory computer-readable storage medium for generating a land use area change detection dataset. Remote sensing practitioners rely on aerial and Earth satellite images of high resolution or greater, where the high resolution or greater is a pixel size of 0.3 m/pixel or less, yet it is difficult and expensive to obtain sufficient multi-temporal data and corresponding labels for training a change detection machine learning model. The disclosed computer-based AI workstation addresses this need by using a user input device for downloading aerial and Earth satellite images of high resolution or greater and selecting a static image from among the aerial and Earth satellite images.

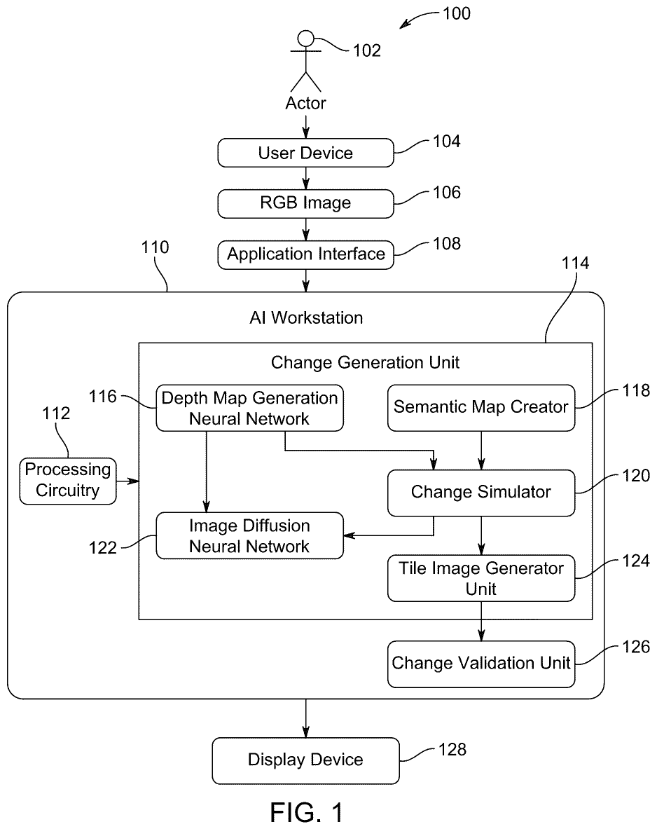

FIG. 1 illustrates a computer based artificial intelligence workstation 110, also referred to as ChangeMaker 110, configured to automatically generate land use area change detection image pairs from aerial and Earth satellite images of high resolution or greater. The AI workstation 110 is an integrated software and hardware platform that orchestrates image acquisition, representation learning, change simulation, image synthesis, validation, and dataset construction within a single end to end pipeline. In an embodiment, for each scene, the AI workstation 110 receives a single static RGB satellite image tile and a desired number of time steps and produces, for each time step, a pair of change tiles and an associated change mask. A pair of change tiles denotes a pre change tile and a post change tile that represent the same geographic scene at two different synthetic states, and a change mask denotes a pixel level map that focuses on one or more objects removed from the static image or otherwise changed within the scene. By iteratively applying this pipeline across the specified number of time steps, the AI workstation 110 generates a time series of progressive changes that form a sequence of change pairs representing the simulated evolution of the scene over time.

The pipeline of FIG. 1 begins with an actor 102 who operates a user device 104. The actor 102 may be a remote sensing engineer, a data scientist, or a software application that orchestrates large scale dataset generation. The user device 104 functions as a user input device configured for downloading aerial and Earth satellite images of high resolution or greater and selecting a static image from among the aerial and Earth satellite images, wherein the high resolution or greater is a pixel size of 0.3 m/pixel or less. In practice, the actor 102 obtains satellite imagery from any remote sensing imagery provider that offers high resolution or very high resolution data, for example 0.5 m/pixel to 0.3 m/pixel, and crops an RGB image 106 that defines a static image tile representing a region of interest such as an urban block or an industrial site. The user device 104 is further configured for inputting a number of time steps to iteratively generate pairs of change image tiles. The RGB image 106 and the number of time steps are supplied from the user device 104 to an application interface 108, so that user specified imagery and temporal configuration parameters are forwarded directly into the AI workstation 110.

The application interface 108 constitutes a software and communications layer that receives the RGB image 106 and the number of time steps from the user device 104 and provides these inputs to the AI workstation 110. The application interface 108 establishes a defined entry point to the AI workstation 110, ensuring that the subsequent processing stages operate on well formed, high resolution imagery and explicit temporal requirements. In this way, the application interface 108 couples user interaction to the internal processing flow of ChangeMaker 110.

Within the AI workstation 110, machine learning processing circuitry 112 provides computational resources to implement the generative and validation operations. The machine learning processing circuitry 112 comprises multi core processors configured to cyclically perform fused multiply add operations, which accelerate the matrix and tensor computations required by deep neural networks used throughout the pipeline. The machine learning processing circuitry 112 is operatively coupled to a change generation unit 114 and to a change validation unit 126 so that both units invoke neural networks and other algorithms using the same multi core processors, thereby providing a unified computational backbone for the entire system.

The change generation unit 114 is a functional block within the AI workstation 110 that receives the RGB image 106 and the number of time steps from the application interface 108 and implements the core generative pipeline. The change generation unit 114 comprises a depth map generation neural network 116, a semantic map creator 118, a change simulator 120, an image diffusion neural network 122, and a tile image generator unit 124, all executed by the machine learning processing circuitry 112. These components operate in sequence so that the outputs of each component form the inputs to the next component, thereby converting the single static RGB image 106 into a pair of change tiles and a change mask.

The depth map generation neural network 116 is configured to infer geometric structure from the RGB image 106. The machine learning processing circuitry 112 is configured to generate, by the depth map generation neural network 116, an original depth map of the static image, where the depth map is an image that contains information relating to distance of surfaces of objects from a viewpoint. In the depth map, pixel intensities represent relative distances of buildings, roads, trees, and other objects from the imaging sensor. The depth information provides three dimensional spatial context that later stages use to ensure that simulated changes respect realistic geometry.

In parallel with or immediately after depth computation, the semantic map creator 118 produces a categorical understanding of scene content. The semantic map creator 118 comprises a semantic segmentation network executed by the machine learning processing circuitry 112. The machine learning processing circuitry 112 is configured to create, by the semantic map creator 118, a semantic map of the static image, wherein the semantic map includes annotated objects in the static image. Each pixel or region is labeled with a semantic class such as building, road, tree, water, or open land. Together, the depth map from the depth map generation neural network 116 and the semantic map from the semantic map creator 118 provide complementary modalities for the same tile, enabling the change generation unit 114 to reason about both geometry and object identity.

Downstream of the depth and semantic representations, the change simulator 120 determines which parts of the scene are to be modified. The change simulator 120 is executed by the machine learning processing circuitry 112 and receives as inputs the original depth map produced by the depth map generation neural network 116 and the semantic map produced by the semantic map creator 118. The machine learning processing circuitry 112 is configured to generate, by the change simulator 120 that iteratively determines a plurality of candidate areas for change simulation, a change depth map and a change mask, wherein the change mask focuses on one or more objects removed from the static image. The change simulator 120 selects candidate regions based on the semantic classes and geometric constraints, removes or alters selected objects on the depth map, and produces a modified change depth map that encodes the intended change while preserving the surrounding scene context. The change mask identifies the spatial extent of the modified objects, and the iterative nature of the change simulator 120 allows multiple candidate areas to be evaluated over successive passes.

The change depth map produced by the change simulator 120 is then supplied to the image diffusion neural network 122. The image diffusion neural network 122 is a generative model executed by the machine learning processing circuitry 112 and is configured to synthesize realistic satellite style imagery conditioned on the depth information. The machine learning processing circuitry 112 is configured to generate, by the image diffusion neural network 122, a pair of change tiles and a mask using the change depth map, wherein the pair of change tiles includes a post change tile and a pre change tile. In one embodiment, the image diffusion neural network 122 is implemented as a stable diffusion pipeline that uses the change depth map as a reference image and also conditions on the original depth map from the depth map generation neural network 116. The stable diffusion pipeline iteratively denoises latent representations so that the pre change tile and the post change tile maintain the global layout of the scene while reflecting the specific modifications encoded in the change depth map and the change mask.

The tile image generator unit 124 is operatively connected to the image diffusion neural network 122 within the change generation unit 114. The tile image generator unit 124 receives the outputs of the image diffusion neural network 122 and formats them as pre change and post change image tiles that are consistent in resolution, viewing angle, and other imaging characteristics. The tile image generator unit 124 associates the change mask from the change simulator 120 with the generated pair of change tiles to form a complete sample comprising the pre change tile, the post change tile, and the change mask. Because the change generation unit 114 operates on depth and semantic modalities rather than handcrafted graphics, the combined operation of the depth map generation neural network 116, the semantic map creator 118, the change simulator 120, the image diffusion neural network 122, and the tile image generator unit 124 produces realistic change tiles that capture fine scale details despite limitations in source image resolution.

The change generation unit 114 also supports progressive and time series simulation across the specified number of time steps. The machine learning processing circuitry 112 is configured to repeat the steps for producing the pair of change tiles and the mask by taking a post change tile of the pair of change tiles, produced at a current time step, as the input for generating the pre and post pair of change tiles and mask for a next time step, in accordance with the number of time steps. This repetition generates a time series of change without modifying a scene of the static image beyond the intended object level modifications and enables ChangeMaker 110 to produce progressive changes from the original two images. By providing many RGB images 106 from different locations to the application interface 108, the actor 102 invokes the change generation unit 114 to generate a proportional number of generated change pairs and masks. The generated change pairs and masks can be used as the input stream for the change validation unit 126.

The change validation unit 126 is a functional block within the AI workstation 110 that validates and scores the generated changes before they are used to build a change detection dataset. The change validation unit 126 receives, from the tile image generator unit 124, the pair of change tiles and the change mask, and applies offline validation to ensure that the changes are realistic and occur at the right place, and do not include hallucinations that are irrelevant, made up, or inconsistent with the input data. Within the change validation unit 126, the machine learning processing circuitry 112 is configured to perform, by a quality assessment module, operations that use each generated change object as a query to perform a search in an object database of ground truth objects; and when there is a similarity to any object in the object database of ground truth objects, properly generate the object. The quality assessment operations intersect the change mask with the generated images to extract individual changed objects, such as candidate buildings, and compare each extracted object to stored ground truth exemplars. When similarity is high, the quality assessment operations confirm that the generated object matches a realistic pattern. When similarity is low, the operations flag the object as potentially invalid.

The change validation unit 126 further comprises a validation module that performs classifier based evaluation in conjunction with the quality assessment module. The machine learning processing circuitry 112 is configured to apply, by the validation module, a classifier network to detect when a generated change object belongs to a certain class, and determine a score based on the classification, and to display the score to show a degree that the generated change object belongs to the certain class. For example, the classifier network can determine whether a given object belongs to a building class versus a nonbuilding class and assign a confidence score for the classification. The change validation unit 126 then uses the similarity scores from the quality assessment module and the confidence scores from the validation module to decide whether the corresponding pair of change tiles should be accepted or rejected for dataset generation. When the pair of change tiles is found invalid, the change validation unit 126 stores an identifier for an invalid pair of change tiles in a rejected list. When the pair of change tiles is found valid, the change validation unit 126 outputs a validated pair of change tiles and a validated change mask.

The output of the change validation unit 126 is represented in FIG. 1 as a change pair and mask on a display device 128. The change pair and mask, displayed in the display device 128, is also stored to external storage, such as a database configured to store the validated pair of change tiles and the validated mask and to organize them into training and testing subsets for downstream change detection models. The rejected list is maintained separately so that invalid pairs are excluded from the change detection dataset while still being available for analysis of failure modes and refinement of the generation and validation pipeline.

In operation, the AI workstation 110 therefore performs a method of remote image change detection that includes downloading, by the user device 104 functioning as the user input device, aerial and Earth satellite images of high resolution or greater, wherein the high resolution or greater is a pixel size of 0.3 m/pixel or less, selecting, by the user device 104, a static image from among the aerial and satellite images, generating, by multi core processors within the processing circuitry 112 that cyclically perform fused multiply add operations for the depth map generation neural network 116, an original depth map of the static image, creating, by the processing circuitry 112 configured with the semantic map creator 118, a semantic map of the static image, generating, by the processing circuitry 112 configured with the change simulator 120 that iteratively determines a candidate area for change simulation, a change depth map and a change mask, generating, by multi core processors that cyclically perform fused multiply add operations for the tile image generator unit 124 implemented with the image diffusion neural network 122, the pair of change tiles and the mask using the change depth map, and storing validated pairs of change tiles and validated masks in the database managing the pairs of change tiles and masks so that change detection models can be trained.

The AI workstation 110 also supports a non transitory computer readable storage medium that stores computer executable instructions. When executed by the AI workstation 110, the instructions cause the computer to perform a method for generating a land use area change detection dataset that uses the same components shown in FIG. 1. The method comprises downloading, by the user device 104, aerial and Earth satellite images of high resolution or greater, wherein the high resolution or greater is a pixel size of 0.3 m/pixel or less, selecting, by the user device 104, a static image from among the aerial and satellite images, generating, by multi core processors that cyclically perform fused multiply add operations for the depth map generation neural network 116 within the processing circuitry 112, the original depth map of the static image, creating, by the processing circuitry 112 configured with the semantic map creator 118, the semantic map of the static image, generating, by the processing circuitry 112 configured with the change simulator 120 that iteratively determines the candidate area for change simulation, the change depth map and the change mask, generating, by multi core processors that cyclically perform fused multiply add operations for the tile image generator unit 124 implemented with the image diffusion neural network 122, the pair of change tiles and the mask using the change depth map, displaying, by a display device coupled to the change validation unit 126, the pair of change tiles and the mask and validating the pair of change tiles to obtain the validated pair of change tiles and the validated mask, wherein when the pair of change tiles are found invalid, storing the identifier for the pair of change tiles in the rejected list, and storing the validated pair of change tiles and the validated mask in the database. The computer readable storage medium further supports inputting, by the user device 104, the number of time steps to iteratively generate pairs of change image tiles, and repeating, by the processing circuitry 112, the steps for producing the pair of change tiles and the mask by taking the post change tile of the pair of change tiles, produced at the current time step, as the input for generating the pre and post pair of change tiles and mask for the next time step, in accordance with the number of time steps, as well as performing, by the quality assessment and validation operations within the change validation unit 126, the similarity based search and classifier based scoring described above. Thereby, FIG. 1 depicts ChangeMaker 110 as a concrete realization of the computer based artificial intelligence workstation, the method of remote image change detection, and the non transitory computer readable storage medium, with each component defined and interconnected so that the output of one component forms the input to the next, providing a coherent and fully integrated system for generating validated land use area change detection image pairs for training datasets.

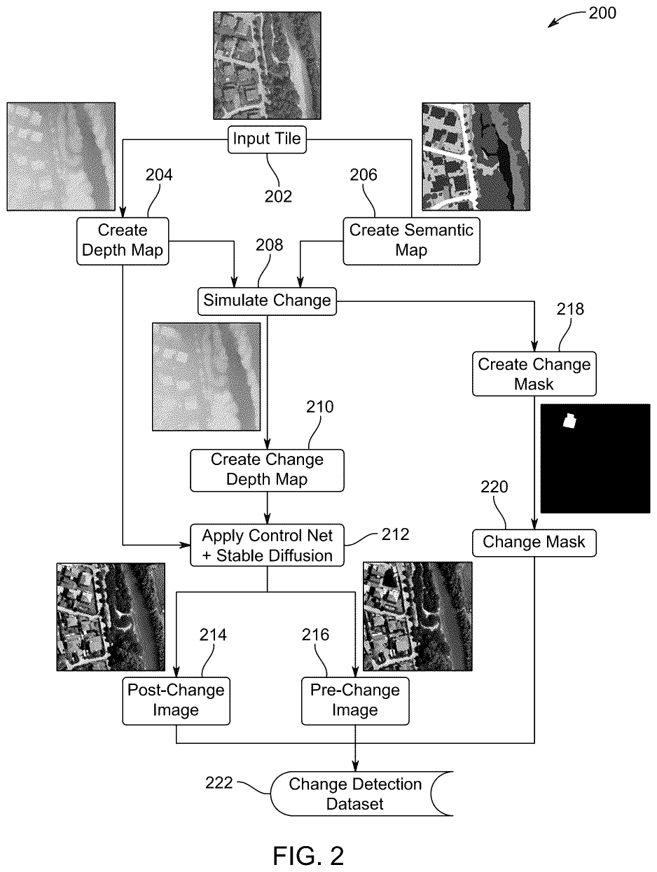

FIG. 2 illustrates a detailed flow diagram of a processing pipeline of a computer based artificial intelligence workstation for generating and validating change detection image pairs. The processing pipeline systematically converts a selected static image tile into a pair of temporally related change tiles along with a corresponding change mask. The outputs collectively form a validated change detection image pair dataset suitable for training and testing change detection machine learning models.

The workstation comprises a user input device configured for downloading aerial and Earth satellite images of high resolution or greater and for selecting a static image from among the aerial and Earth satellite images. As used herein, high resolution refers to satellite or aerial imagery having a pixel size of 0.3 meters per pixel or less, which enables the identification and analysis of small scale features and objects on the Earth's surface. Very high resolution imagery typically exhibits pixel sizes of 0.5 meters per pixel or finer, providing exceptional detail for applications requiring precise object detection and classification.

A static image tile 200 serves as the foundational input to the processing pipeline. The static image tile 200 comprises a cropped portion or tile extracted from a larger high resolution or very high resolution satellite image or aerial photograph. In the illustrated embodiment, the static image tile 200 depicts an urban or suburban area containing various objects such as buildings, roads, vegetation including trees, and other infrastructure elements. The static image tile 200 is selected by a user through the user input device based on a specific area of interest for which change detection analysis is desired. The pixel size of the static image tile 200 is 0.3 meters per pixel or less, thereby providing sufficient spatial resolution to identify and track changes in individual objects and features within the scene. An input tile block 202 identifies the static image tile 200 and indicates that this tile constitutes the primary input to the subsequent processing operations. The static image tile 200 thus serves as a snapshot representing a particular moment in time and captures the spatial arrangement and characteristics of objects present within the geographic area of interest.

The workstation further comprises machine learning processing circuitry operatively connected to the user input device. The machine learning processing circuitry comprises multi core processors configured to cyclically perform fused multiply add operations. Fused multiply add operations compute the product of two numbers and add a third number in a single step, which significantly accelerates the mathematical computations required for deep neural network inference. The multi core processors execute these operations cyclically and in parallel across multiple processing cores, thereby enabling efficient processing of the large scale matrix operations that make up neural network computations. The machine learning processing circuitry may comprise, for example, graphics processing units, tensor processing units, or other specialized AI accelerators optimized for parallel fused multiply add operations.

Upon receiving the static image tile 200, the machine learning processing circuitry directs the tile to multiple parallel processing paths. A first processing path leads to a depth map generation module 204 indicated as “Create Depth Map.” The depth map generation module 204 implements a depth map generation neural network specifically trained to analyze two dimensional imagery and infer three dimensional depth information. The depth map generation neural network employed by the module 204 may comprise a convolutional neural network architecture configured to predict relative distances of surfaces of objects from a viewpoint, for example, a camera. The depth map generation neural network can be implemented using DepthPro, or equivalent thereof. The depth map generation module 204 generates, by means of the depth map generation neural network, an original depth map of the static image tile 200. The original depth map constitutes an image representation wherein pixel intensity values or color encodings represent distance information relating to the distances of surfaces of objects from the viewpoint, typically the camera or sensor perspective from which the static image was captured. In the depth map, closer surfaces may be represented by lighter or warmer colors, while more distant surfaces may be represented by darker or cooler colors. The depth map provides three dimensional spatial context that enables subsequent processing modules to understand geometric relationships between objects in the scene and to generate realistic changes that respect these spatial relationships.

Concurrently, the machine learning processing circuitry directs the static image tile 200 along a second parallel processing path to a semantic map creation module 206 indicated as “Create Semantic Map.” The semantic map creator 206 comprises a semantic segmentation neural network configured to classify each pixel or region of the static image tile 200 into predefined categorical classes. The semantic segmentation neural network can be implemented using SeqFormer, or equivalent thereof. The semantic map creator 206 generates a semantic map of the static image tile 200, wherein the semantic map includes annotated objects identified within the static image tile 200. Each object or region in the semantic map is labeled according to its semantic class, such as building, tree, road, grass, water, vehicle, or other relevant categories depending on the application domain. The semantic map thus provides a structured, categorical understanding of the scene content and identifies what objects are present and where they are located within the image.

Following the parallel generation of the original depth map by the module 204 and the semantic map by the module 206, the machine learning processing circuitry provides both the depth map and the semantic map as inputs to a change simulation module 208 indicated as “Simulate Change.” The change simulation module 208 comprises a change simulator that receives the depth map, the semantic map, and optionally other contextual information to determine appropriate locations and types of changes to simulate within the scene. The change simulator operates iteratively, meaning it performs multiple processing cycles to refine and determine candidate areas for change simulation. During its iterative operation, the change simulator analyzes the semantic map to identify objects that are suitable candidates for modification or removal and determines, through this iterative process, which objects to modify and the nature and extent of the modifications. An intermediate representation between the module 208 and subsequent stages is depicted as a grayscale image showing a simulated change scenario in which certain objects have been conceptually removed or modified from the original scene while other elements remain unchanged.

The change simulator in the module 208 generates two primary outputs during its iterative processing, a change depth map and a change mask. The change depth map represents an updated or modified version of the original depth map and reflects a three dimensional spatial configuration of the scene after the proposed changes have been applied. A change mask 220 focuses on identifying one or more objects removed from or modified in the static image tile 200. The change mask 220 is a binary or multi valued mask image wherein pixels corresponding to changed regions are assigned one value and pixels corresponding to unchanged regions are assigned a different value. The change mask 220 explicitly delineates a spatial extent and location of anticipated changes within the scene.

The change depth map generated by the change simulator 208 is supplied to a change tile generation module 210 indicated as “Create Change Depth Map.” The module 210 receives the change depth map as an input and utilizes it, in combination with other control information, to generate changed imagery. The change tile generation module 210 comprises an image diffusion neural network configured to generate realistic image content based on depth information, semantic information, and control inputs.

The change tile generation module 210 applies a control network such as a ControlNet architecture 212 indicated as “Apply Control Net +Stable Diffusion.” ControlNet is a neural network structure to control diffusion models by adding extra conditions. The control network 212 works in conjunction with a stable diffusion process to guide the image generation procedure. Stable diffusion is a generative model that creates images by iteratively denoising random noise according to learned patterns and guided by conditioning inputs such as the change depth map and semantic information. The control network 212 provides additional guidance to ensure that the generated images respect specified depth structure and semantic content.

Through the application of the control network 212 and the stable diffusion process, the change tile generation module 210 generates a pair of change tiles. This pair of change tiles comprises a post change image tile 214 indicated as “Post Change Image” and a pre change image tile 216 indicated as “Pre Change Image.” Both the post change tile 214 and the pre change tile 216 appear as satellite or aerial view images showing the same geographic area but at different temporal states. The post change image tile 214 depicts the scene in its modified or altered state and shows the appearance of the area after simulated changes have occurred. The pre change image tile 216 depicts the scene prior to the occurrence of the specified changes and shows an original state or an earlier state of development. Together, the pre change tile 216 and the post change tile 214 form a temporally ordered pair that captures a progression of change within the scene while maintaining consistency in unchanged elements such as roads, surrounding buildings, vegetation, and other static features. In the illustrated embodiment, the post change tile 214 is positioned on a left side of the pipeline, and the pre change tile 216 is positioned on a right side. Both tiles are generated by the module 210 using the image diffusion neural network and thus maintain consistent imaging characteristics such as lighting, viewing angle, atmospheric conditions, and spatial resolution while differing only in specific changes introduced by the change simulation process.

Concurrent with or subsequent to the generation of the pair of change tiles, a change mask creation module 218 indicated as “Create Change Mask” processes information from the change simulator 208 to generate a refined change mask 220. The change mask creation module 218 may refine an initial change mask produced by the change simulator 208 or may generate the change mask 220 based on analysis of differences between the pre change tile 216 and the post change tile 214. The change mask 220 is depicted as a binary black and white image in which white regions indicate areas where changes have occurred, such as locations of removed or modified buildings, and black regions indicate areas that have remained unchanged between the pre change and post change states.

The machine learning processing circuitry of the workstation is configured to output the pair of change tiles, namely the pre change tile 216 and the post change tile 214, and the change mask 220 to a display device. The display device is configured to display the pair of change tiles and the change mask for validation purposes. A human validator or an automated validation system examines the displayed images to assess a quality and realism of the generated changes. During validation, the validator determines whether the pair of change tiles is valid or invalid based on criteria such as whether changes occur at appropriate and realistic locations, whether the changes exhibit realistic visual characteristics consistent with actual temporal changes observed in satellite imagery, whether objects that should remain unchanged are properly preserved between the pre change and post change images, and whether the changes are hallucinations or artificial artifacts that would make them unsuitable for training change detection models. A validated pair of change tiles accurately represents realistic temporal evolution of the scene without introducing spurious or impossible changes.

When the pair of change tiles 214 and 216 and the change mask 220 are determined to be valid through the validation process, the machine learning processing circuitry stores the validated pair of change tiles and the validated change mask in a database 222 indicated as “Change Detection Dataset.” The change detection dataset 222 accumulates validated examples of temporal changes and builds a corpus of high quality training data suitable for supervised learning of change detection algorithms.

Conversely, when the pair of change tiles is found to be invalid, for example because changes appear unrealistic, occur in inappropriate locations, introduce hallucinations such as distorted buildings or impossible structures, or fail to preserve unchanged scene elements, the processing circuitry stores an identifier for the invalid pair of change tiles in a rejected list. The rejected list catalogs unsuccessful generation attempts, enables analysis of common failure modes, and supports refinement of the image generation pipeline. The identifier may comprise a unique file name, a database key, or another reference that allows the specific invalid image pair to be identified and excluded from the training dataset.

The validation mechanism implemented through the display device, the change detection dataset 222, and the rejected list serves multiple functions. The validation mechanism ensures that only high quality, realistic change pairs are included in the change detection dataset 222, prevents propagation of low quality or misleading training examples, addresses hallucinations that can arise in generative AI models, enables rapid generation of large scale validated datasets by allowing automated generation to produce many candidate change pairs that are then filtered through validation, and provides feedback for improving generation models and change simulation algorithms over time.

The change detection dataset 222 resulting from this image generation pipeline serves as a resource for training and testing change detection models such as ChangeFormer, U Net, or other architectures designed to detect and classify changes between multi temporal image pairs. The dataset can be partitioned into training and testing subsets and supports applications including urban development monitoring, construction progress tracking, disaster damage assessment, deforestation detection, and infrastructure analysis.

The complete processing pipeline illustrated in FIG. 2 therefore provides an end to end system for automated image generation, validation, and curation of change detection training data. Beginning with the single static image tile 200, the pipeline leverages multiple specialized neural networks, including the depth map generation neural network in the module 204, the semantic segmentation network in the module 206, the change simulation algorithms in the module 208, and the image diffusion neural network with control network 212 in the module 210, to synthesize realistic temporal image pairs. The addition of the validation step and database storage mechanism ensures dataset quality and enables accumulation of large scale, diverse, and validated training data that addresses limitations of existing change detection datasets, which often suffer from small size, limited diversity, annotation errors, and lack of progressive change examples. Furthermore, the pipeline is model agnostic in its architecture, meaning that specific neural network implementations for depth map generation, semantic segmentation, change simulation, and image generation can be substituted or upgraded without fundamentally altering the overall processing flow. This flexibility enables the system to incorporate advances in computer vision and generative modeling as new architectures and techniques become available and ensures long term relevance and continued improvement in generation quality.

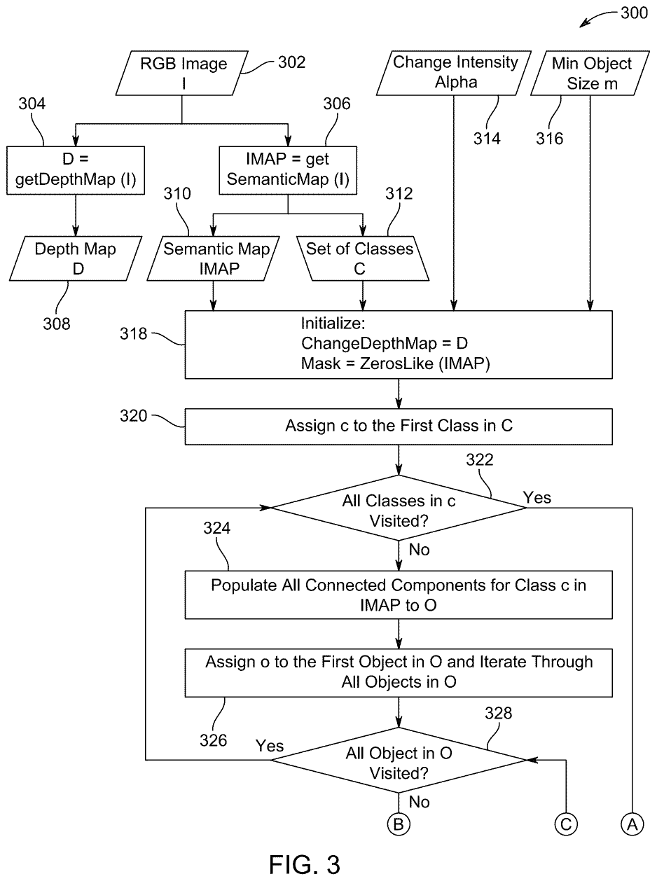

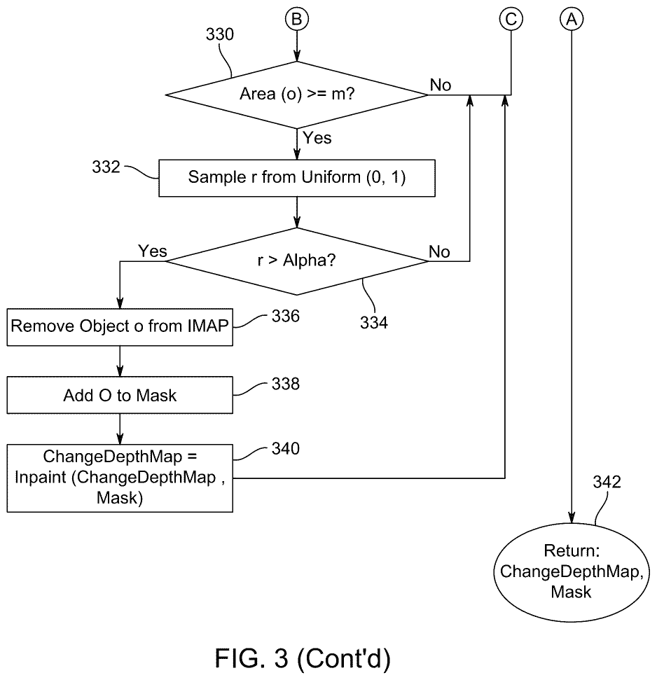

FIG. 3 is a flow diagram illustrating a change simulator 300 implemented within the change generation unit 114 of the computer based artificial intelligence workstation 110. The change simulator 300 is configured to iteratively determine candidate areas for change simulation and to generate a change depth map and a change mask that focus on one or more objects removed from a static image. The change simulator 300 operates on outputs of a depth map generation neural network and a semantic map creator and incorporates changes into a determined candidate area in an original depth map using image inpainting, thereby producing inputs that are subsequently consumed by an image diffusion neural network for generating a pair of change tiles.

At the input stage, an RGB image 302 corresponds to the static image tile selected by the user input device 104 through the application interface 108. The RGB image 302 is provided simultaneously to a depth extraction operation 306 and to semantic analysis operations that together implement the depth map generation neural network and the semantic map creator. The depth extraction operation 306 computes an original depth map from the RGB image 302 by estimating, for each pixel, a distance of surfaces of objects from a viewpoint. The result of this operation is stored as a depth map 308, denoted D, which serves as an image that contains information relating to distance of surfaces of objects from the viewpoint. In parallel, the semantic analysis operation of block 306 applies the semantic map creator to the RGB image 302 to produce a semantic map 310, denoted IMAP, which includes annotated objects in the static image such as buildings, roads, vegetation, and water bodies. From the semantic map 310, a set of classes 312, denoted C, is derived, where each class in the set of classes 312 represents a semantic category present in the static image, for example a building class, a road class, or a tree class.

In addition to the imagery derived inputs, the change simulator 300 receives change control parameters that enable fine grained adjustment of how many objects are selected for removal or modification. A change intensity parameter 314, denoted alpha, defines a probability threshold used to determine whether a candidate object is selected as a change object. A minimum object size parameter 316, denoted m, defines a minimum pixel area that an object must exceed before it is eligible to be considered as a candidate area for change simulation. These parameters allow the system designer or user to control the density and scale of simulated changes in the generated dataset while preserving realism.

The initialization block 318 prepares the internal state of the change simulator 300 prior to iterative processing. In block 318, a change depth map variable, denoted ChangeDepthMap, is initialized to the original depth map D derived from the depth map 308, and a change mask variable, denoted Mask, is initialized as an image of zeros with the same spatial dimensions as the semantic map 310. Conceptually, this means that at the start of the simulation no object has been removed and the change depth map is identical to the original depth map. The Mask is reserved to accumulate pixels corresponding to objects selected for removal or modification.

Processing then proceeds to class level iteration. In block 320, a class variable c is assigned to the first class in the set of classes 312. Decision block 322 determines whether all classes in the set of classes 312 have been visited. If all classes have already been processed, control advances to the inpainting stage described below. If not all classes have been visited, the flow continues to block 324, where the change simulator 300 populates all connected components for the current class c in the semantic map 310 into an object set denoted O. Each connected component in O represents a distinct object instance of the current class within the semantic map, for example an individual building polygon belonging to the building class. In this way, the semantic map 310 and the set of classes 312 drive the identification of candidate areas for change simulation at the level of individual objects.

Once the set of connected components O for the current class c has been constructed, processing advances to object level iteration. In block 326, an object variable o is assigned to the first object in the set O, and the change simulator 300 begins iterating through all objects in O. Decision block 328 checks whether all objects in the set O have been visited. If all objects have been processed, the class iteration proceeds by returning to block 320 to assign c to the next class in the set of classes 312 and repeating the above steps, until decision block 322 eventually determines that all classes in the set of classes 312 have been visited. If not all objects in the set O have been visited, the flow proceeds to decision block 332, where a geometric eligibility test is performed for the current object o.

Decision block 330 evaluates whether an area of the object o, denoted area(o), is greater than or equal to the minimum object size m provided by parameter 316. If the area of the object o is less than the minimum object size m, the object o is deemed too small to be considered a candidate area for change simulation, and the algorithm returns to block 328 to determine whether all objects in the set O are visited. At block 330, it is determined that if the area of the object o is greater than or equal to the minimum object size m, then the current object o satisfies the size condition for candidate selection, and the flow advances to block 332.

In block 332, the change simulator 300 samples a random variable r from a uniform distribution over the interval from 0 to 1. This random sampling introduces stochasticity into the selection process, allowing the simulator to generate diverse change realizations even for the same static image tile, while still respecting global intensity constraints. Decision block 334 compares the sampled random value r with the change intensity parameter alpha from block 314. If the condition r greater than alpha is not satisfied, the current object o is not selected for removal in this iteration, and control returns to block 330 to determine whether the Area (o) is greater than m. If the condition r greater than Alpha is satisfied, the current object o is selected as a candidate area for change simulation, and the flow proceeds to blocks 336 and 338 to apply the selection.

In block 336, the change simulator 300 removes the object o from the semantic map 310 by updating the internal representation IMAP. This removal operation ensures that the selected object no longer appears in the semantic map for subsequent stages, effectively simulating that the corresponding structure or land cover has been removed from the scene. In block 338, the same object o is added to the Mask, meaning that all pixels corresponding to the object o are marked in the change mask variable. As the algorithm iterates over classes and objects, multiple objects that satisfy the size and random selection criteria are cumulatively added to the Mask. Consequently, by the time all classes in the set of classes 312 and all objects in each set O have been visited, the Mask represents a consolidated change mask that focuses on one or more objects removed from the static image and precisely delineates their spatial extent.

After the iterative loops have processed all classes and all eligible objects, the flow exits the class and object loops at decision block 322 and advances to block 340. In block 340, the change simulator 300 incorporates changes into the determined candidate areas in the original depth map using image inpainting. Specifically, block 340 updates the change depth map variable by computing ChangeDepthMap equal to an inpainting operation applied to the current ChangeDepthMap using the accumulated Mask as a guide. Any image inpainting technique may be applied. The inpainting operation fills in depth values at pixel locations indicated by the Mask by interpolating or extrapolating depth information from surrounding pixels, thereby producing a coherent change depth map that no longer contains the removed objects while preserving the surrounding scene geometry. Through this operation, the change simulator 300 transforms the original depth map into a change depth map that is consistent with the simulated removal of objects identified in the Mask, while leaving unselected regions unchanged.

Finally, a return block 342 outputs the results of the change simulator 300 to the downstream stages of the change generation unit 114. The return block 342 provides the change depth map and the change mask as outputs. The change depth map is subsequently used by the image diffusion neural network 124 as a conditioning reference for generating a pair of change tiles, and the change mask is used both to guide the image diffusion neural network and to provide pixel level supervision for downstream change detection models. Together, the change depth map and the change mask generated by the change simulator 300 implement the functionality of iteratively determining candidate areas for change simulation, generating a change depth map and a change mask focusing on one or more objects removed from the static image, and incorporating changes into a determined candidate area in the original depth map using image inpainting, thereby enabling the workstation 100 to synthesize realistic and structurally consistent change images for land use area change detection.

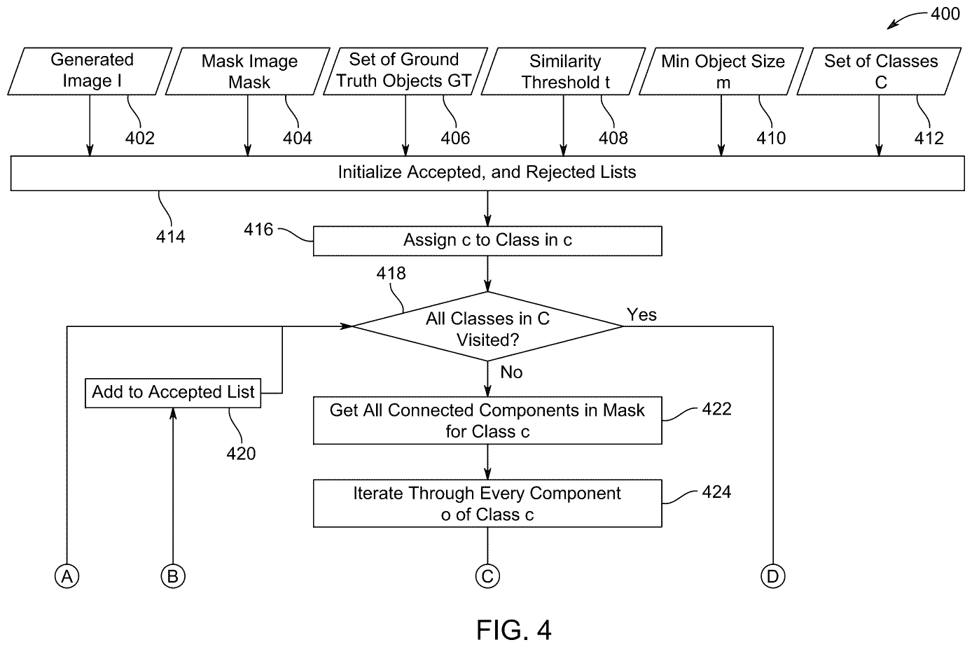

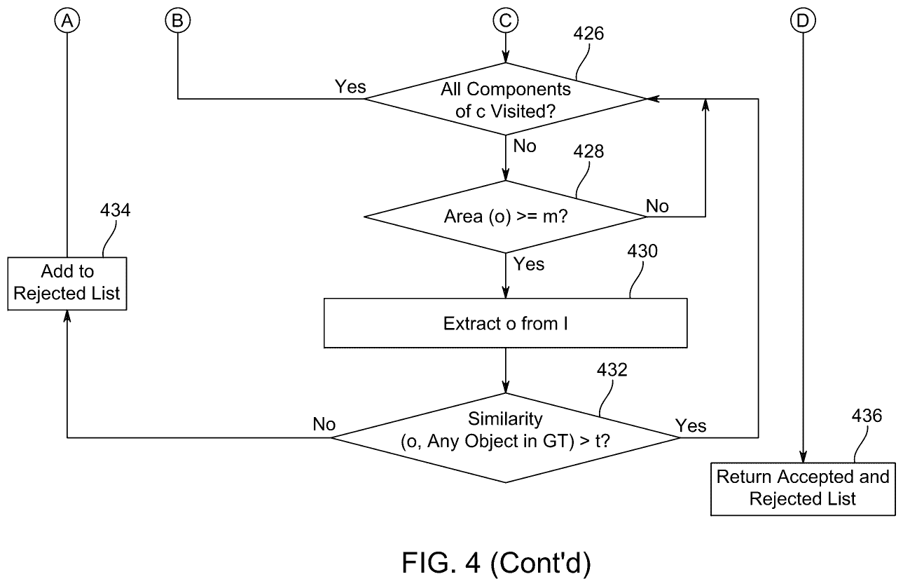

FIG. 4 illustrates a detailed flowchart of a change validation unit that implements a systematic validation process for evaluating generated change image pairs and their associated masks to ensure the quality and accuracy of a change detection dataset. The change validation unit receives multiple inputs and performs a series of algorithmic steps to determine whether a generated change pair should be accepted into the validated dataset or rejected based on predefined quality criteria.

The change validation unit receives as inputs data elements that are processed collectively to assess the validity of generated change pairs. A first input comprises a generated image 402 which corresponds to one of the change tiles generated by the image diffusion neural network of the processing circuitry. The generated image 402 represents either a pre-change image tile or a post-change image tile that has been synthesized through a stable diffusion process controlled by a control network. A second input comprises a mask image 404, which corresponds to a change mask that identifies regions of change between the pre-change and post-change images. The mask image 404 provides spatial information indicating which pixels or regions have undergone modification during a simulated temporal change process.

A third input comprises a set of ground truth objects 406, designated as GT, which provides reference information about known valid objects that should be present in scenes of the type being generated. The set of ground truth objects 406 serves as a reference standard against which generated objects are compared to verify their realism and accuracy. A fourth input comprises similarity threshold t 408, which defines numerical criteria for determining a degree of correspondence or similarity between generated objects and ground truth objects. The similarity threshold t 408 provides quantitative benchmarks that must be satisfied for a generated object to be considered sufficiently similar to valid reference objects.

A fifth input comprises a minimum object size parameter 410, designated as s, which specifies smallest acceptable object dimensions for validation purposes. The minimum object size 410 filters out spuriously small regions that may result from generation artifacts or noise in the mask image 404. A sixth input comprises a set of classes 412, designated as C, which defines categorical classifications of objects that should be present in valid images. The set of classes 412 may include categories such as buildings, trees, roads, vehicles, water bodies, and other object types relevant to a satellite or aerial imagery domain. These input parameters 402, 404, 406, 408, 410, and 412 are provided to an initialization process 414 that accepts and registers these inputs into a validation workflow. The initialization step 414 initializes data structures and parameters necessary for subsequent validation operations, establishing a computational environment for a validation algorithm.

Following the initialization 414 of the input parameters, the change validation unit performs a class assignment operation 416 wherein the system assigns a class to each class in C. The class assignment operation 416 ensures that every object class defined in the set of classes 412 is properly registered and available for subsequent similarity matching and validation operations. The class assignment 416 creates a mapping between classes present in the generated image 402 and expected classes defined in the set of classes 412, enabling systematic evaluation of whether all expected object types are appropriately represented in generated imagery.

After the class assignment operation 416, the change validation unit encounters a first decision point 418 that determines whether all classes are deleted or not. The first decision point 418 evaluates whether the generated image 402 has eliminated all object classes that should be present according to the set of classes 412. This evaluation assesses whether a generation process has inappropriately removed all expected object categories, which would indicate a fundamental failure in maintaining scene content. If the determination at the first decision point 418 is affirmative (YES), indicating that all classes have been improperly deleted from the generated image 402, the validation process proceeds directly along a first rejection path to add the generated image 402 to an accepted list 420. The accepted list 420, despite its nomenclature in the figure, actually receives entries when classes are deleted, suggesting this path leads to segregation of images requiring special handling. More precisely, when all classes are deleted, the system recognizes this as a specific scenario where an image represents complete removal of all objects, which may or may not be valid depending on an application context. However, based on a rejection principle articulated in the claims, when fundamental criteria are not met, an identifier is more appropriately directed toward a rejected list pathway.

If the determination at the first decision point 418 is negative (NO), indicating that at least some classes remain present in the generated image 402, the change validation unit proceeds to perform a connected component extraction operation 422. The connected component extraction 422 gets all connected components in Mask, referring to the mask image 404. This operation performs a connected component analysis on the mask image 404 to identify distinct, spatially connected regions that represent individual changed or unchanged objects within a scene. Connected component analysis segments the binary or multi-valued mask image 404 into discrete components, each representing a contiguous region of pixels sharing similar mask values. The connected component extraction 422 enables individual object-level validation rather than global image-level validation, allowing the system to evaluate each distinct object or changed region independently according to validation criteria.

Following the connected component extraction 422, the change validation unit initiates an iterative process to evaluate each component individually. The system begins an iteration operation 424 to iterate through every component of the set of class C. The iteration operation 424 examines each connected component sequentially to determine its validity according to multiple criteria including size, similarity to ground truth, and proper classification. The iteration 424 establishes a loop structure wherein each component undergoes systematic evaluation before the system proceeds to a next component.

For each component under examination during the iteration 424, the change validation unit encounters a second decision point 426 that evaluates whether all components are valid or not. The second decision point 426 assesses whether a currently examined component satisfies validation criteria established by the similarity thresholds 408, the minimum object size 410, and correspondence to the ground truth objects 406. If the determination at the second decision point 426 indicates that all components are valid (YES), the validation process proceeds to a completion stage, as all components have successfully passed the validation criteria. If the determination indicates that the components are not all valid (NO), suggesting that a current component fails one or more validation criteria, the process proceeds to further evaluation steps to characterize the nature of a validation failure.

When the second decision point 426 determines that components are not all valid (NO), the change validation unit proceeds to a third decision point 428 that evaluates whether an area of the component under examination is greater than or equal to a minimum object size threshold. The third decision point 428 specifically evaluates whether Area(c)>=s, where Area(c) represents the spatial extent or pixel count of a current component c, and s represents the minimum object size 410 provided as an input parameter. This size check ensures that only objects of sufficient spatial extent are considered for detailed validation, and it filters out noise, artifacts, or spuriously small regions that may result from generation errors, mask irregularities, or insignificant image features that do not represent meaningful objects in a scene.

If the area evaluation at the third decision point 428 determines that the component size is insufficient (NO), meaning Area(c)<s, the component is considered too small to constitute a valid object requiring similarity evaluation. In this scenario, the change validation unit loops back along a feedback path to the iteration operation 424 to continue iterating through remaining components, effectively skipping the undersized component without further analysis and without adding the generated image 402 to the rejected list solely based on the presence of small components. If the area evaluation at the third decision point 428 determines that the component size is sufficient (YES), meaning Area(c)>=s, the component represents a potentially significant object that warrants detailed similarity analysis. The change validation unit then proceeds to an extraction operation 430 for further processing.

When a component of adequate size is identified at the third decision point 428, the change validation unit performs the extraction operation 430 wherein the system extracts information from the component designated as c. The extraction operation 430 retrieves the spatial extent, pixel values, features, and other characteristics of the component c that will be utilized in subsequent similarity evaluation. The extraction operation 430 prepares the component data for comparison against the ground truth objects 406.

Following the extraction operation 430, the change validation unit proceeds to a fourth decision point 432 that performs a similarity evaluation. The fourth decision point 432 specifically determines whether the similarity between the component object c in the generated image 402 and corresponding objects in the ground truth set 406 exceeds a predefined threshold T from the similarity thresholds 408. The fourth decision point 432 evaluates whether similarity(o, any object in GT)>T, where any object refers to the nearest neighbor object in the ground truth set 406, identifying the ground truth object most similar to the generated component c. The similarity metric may be computed using methods such as intersection-over-union, structural similarity index, feature-based matching using deep learning embeddings, or other quantitative measures of correspondence between the generated object and reference ground truth objects 406. The threshold T from the similarity thresholds 408 establishes a minimum acceptable similarity value for validation.

If the similarity evaluation at the fourth decision point 432 determines that the similarity is insufficient (NO), meaning similarity(O, any object in GT)<=T, this indicates that the generated component c does not sufficiently match any ground truth object from the set 406. This insufficient similarity suggests that the generated image 402 contains unrealistic, hallucinated, or improperly synthesized objects that do not correspond to valid reference objects. In this scenario, the change validation unit proceeds along a second rejection path 434 to add the generated image 402 to a rejected list 434, as the presence of objects that do not correspond to valid ground truth references indicates an invalid generation unsuitable for inclusion in a validated change detection dataset.

If the similarity evaluation at the fourth decision point 432 determines that the similarity is sufficient (YES), meaning similarity(o, any object in GT) >T, this indicates that the component c represents a realistic object consistent with expected scene content as defined by the ground truth objects 406. In this scenario, the component c is considered validated, and the change validation unit returns along a feedback path to the iteration operation 424 to continue evaluating remaining components in the set of class C. The change validation unit continues the iterative process established by the iteration operation 424, cycling through each component extracted from the mask image 404 by the connected component extraction 422, evaluating each component according to the size criterion at the third decision point 428 and the similarity criterion at the fourth decision point 432, until all components in the set of class C have been examined according to the validation criteria.

When the iteration operation 424 completes its processing of all components, and the second decision point 426 determines that all components are valid (YES), the change validation unit proceeds to a final output operation 436. The output operation 436 returns accepted and rejected lists as final outputs of the validation process. The output operation 436 generates structured data comprising identifiers for images that have been accepted and identifiers for images that have been rejected based on the validation criteria. The accepted list comprises identifiers for generated image pairs, specifically the generated image 402 and its corresponding pre-change or post-change counterpart, that have successfully passed all validation criteria. These validation criteria include proper class retention as evaluated at the first decision point 418, adequate component sizes as evaluated at the third decision point 428, and sufficient similarity to ground truth objects 406 as evaluated at the fourth decision point 432. The accepted image pairs, along with their associated mask images 404, are stored in a change detection dataset designated as reference numeral 222 in FIG. 2, forming validated training examples for change detection model development.

The rejected list, which accumulates entries through the first rejection path 420 when all classes are deleted and through the second rejection path 434 when similarity thresholds are not met, comprises identifiers for generated image pairs that have failed one or more validation criteria. These rejected pairs include images wherein all expected classes have been improperly deleted, images containing components that fail similarity checks despite meeting size requirements, or images containing unrealistic objects that do not match the ground truth objects 406. The rejected list is cataloged separately to enable analysis of failure modes, identification of systematic generation errors, and potential refinement of generation pipeline parameters, but these rejected pairs are excluded from the validated change detection dataset to maintain dataset quality and prevent introduction of unrealistic or erroneous training examples.

The change validation unit illustrated in FIG. 4 operates in conjunction with the processing pipeline illustrated in FIG. 2, receiving as inputs the generated image 402, corresponding to either the pre-change tile 216 or post-change tile 214, the mask image 404, corresponding to the change mask 220, and additional reference parameters including the ground truth objects 406, similarity thresholds 408, minimum object size 410, and set of classes 412. The change validation unit implements validation functionality recited in the claims wherein a display device is configured to display a pair of change tiles and a change mask to obtain a validated pair of change tiles and a validated change mask.

The systematic evaluation performed by the change validation unit ensures that generated change pairs represent realistic changes at appropriate locations by comparing generated objects against ground truth references using the similarity thresholds 408, size criteria from the minimum object size 410, and class retention checks against the set of classes 412. When a pair of change tiles is found invalid due to failed similarity checks at the fourth decision point 432, improper class deletion at the first decision point 418, or other criteria violations, an identifier for the invalid pair is stored in the rejected list as claimed in the invention. Conversely, when the pair of change tiles is found valid through successful completion of all validation checks, the validated pair and validated mask are stored in a database, specifically the change detection dataset 222.

The change validation unit thus ensures that only high-quality, realistic change pairs free from hallucinations and containing valid objects at appropriate scales and with sufficient correspondence to ground truth references are included in a final validated change detection dataset. This validation mechanism addresses a critical problem of dataset quality that plagues existing change detection datasets, which often suffer from small size, limited diversity, annotation errors, and lack of progressive change images. By providing automated yet rigorous validation, the system enables generation of a large quantity of validated training data suitable for robust change detection model development while maintaining integrity and realism necessary for effective model training.

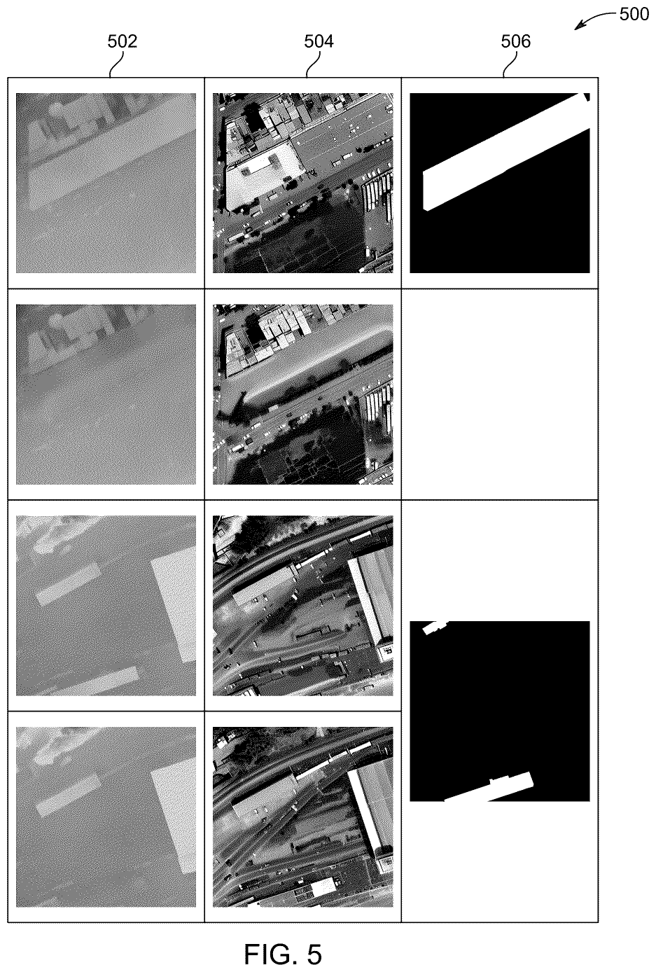

FIG. 5 illustrates visual inspection results produced by the change generation unit 107 of the computer based artificial intelligence workstation 100. Each row in FIG. 5 corresponds to a different static image tile processed by ChangeMaker 110 to generate a pair of change tiles and a change mask based on high resolution or very high resolution aerial and Earth satellite images. The figure is organized into three columns that show, from left to right, depth maps 502, generated images 504, and change masks 506. Together, these visualizations demonstrate how the depth map generation neural network, the change simulator, and the image diffusion neural network cooperate to create realistic change examples while maintaining the characteristic structure of the scene.

In the left column of FIG. 5, the depth maps 502 represent original depth maps generated, by the depth map generation neural network, from static RGB satellite image tiles. Each depth map 502 encodes distance of surfaces of objects from a viewpoint, with pixel intensities or color gradients indicating relative elevation and distance. These depth maps 502 originate from high resolution or very high resolution satellite imagery, for example imagery with pixel size of 0.3 meters per pixel or less, and they capture detailed three dimensional information for objects such as buildings, roads, and surrounding infrastructure. The depth maps 502 serve as conditioning inputs to the change simulator and to the stable diffusion pipeline so that any generated change respects underlying geometry of the scene.

The middle column of FIG. 5 shows generated images 504 that correspond to change tiles produced by the image diffusion neural network using the change depth map and, in some cases, the original depth map as references. Each generated image 504 represents either a pre change tile or a post change tile from a pair of change tiles, and the generated image 504 maintains visual characteristics of the original high resolution satellite image, including perspective, lighting, and urban style. In the examples shown, the generated images 504 depict realistic scenes in which buildings, roads, and vegetation appear consistent with remote sensing imagery from real cities. Objects that the change simulator selected for modification exhibit altered presence or structure between pre change and post change representations, while unchanged objects remain visually stable. The generated images 504 therefore illustrate the ability of the image diffusion neural network, guided by the change depth map and semantic information, to produce change tiles that are suitable for inclusion in a land use area change detection dataset.

The right column of FIG. 5 presents change masks 506 associated with the corresponding generated images 504. Each change mask 506 is a binary or multi valued image that focuses on one or more objects removed from or modified in the static image tile, in accordance with the change mask generated by the change simulator. White regions in each change mask 506 highlight pixels where changes occur, such as locations of new or removed buildings, while black regions indicate areas that remain unchanged between the pre change tile and the post change tile. Comparison among the depth maps 502, the generated images 504, and the change masks 506 in each row shows that the simulated changes appear at the right place and that unchanged structures, including roads and surrounding buildings, remain stable. These visual inspection results align with quantitative improvements, such as the observed increase in F1 and Intersection over Union metrics when a change detection model like ChangeFormer trains on a change detection dataset augmented with generated pairs produced by ChangeMaker 110. FIG. 5 therefore demonstrates that the pipeline generates realistic pairs of change tiles and corresponding change masks while preserving overall scene characteristics, which enhances reliability of the change detection dataset stored in the dataset database 119.

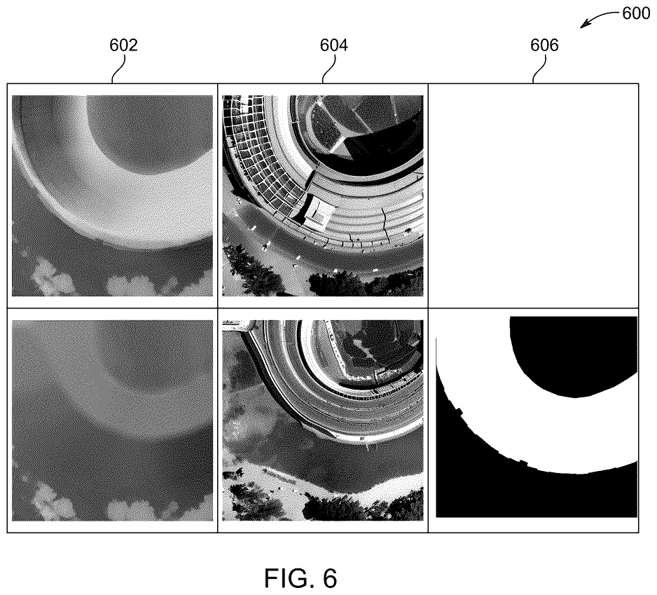

FIG. 6 illustrates an example of progressive change generated by the same pipeline, thereby demonstrating the ability of ChangeMaker 110 to generate a time series of change images without modifying a scene of a static image beyond intended object level modifications. The rows in FIG. 6 correspond to successive time steps produced by repeating the steps for generating a pair of change tiles and a change mask, while taking a post change tile produced at a current time step as an input for generating a pre change tile and a post change tile for a next time step. As in FIG. 5, the columns show depth maps 602, generated images 604, and change masks 606, respectively.

In the left column of FIG. 6, the depth maps 602 correspond to original depth maps and change depth maps at different simulated time steps. The upper depth map 602 represents a state of the scene at an earlier time step, while the lower depth map 602 represents the same scene after additional simulated changes. Shade variations in the depth maps 602 show that the geometric structure of the environment remains consistent for unchanged regions, while the area corresponding to the evolving building changes in depth as construction progresses. The sequence of depth maps 602 thus encodes a progression of the same object's three dimensional structure across multiple time steps.

The middle column of FIG. 6 shows generated images 604 that correspond to change tiles created by the image diffusion neural network at the respective time steps. The upper generated image 604 depicts an earlier stage of building construction, and the lower generated image 604 depicts a later stage in which the building exhibits a more complete or altered form. Throughout this progression, other objects in the scene, such as trees, roads, and surrounding infrastructure, remain unchanged and retain consistent appearance. The generated images 604 therefore exemplify a progressive pair of change tiles that modifies an object without modifying a scene of the static image, in which the system generates a time series change that reflects realistic development of a building while preserving context.

The right column of FIG. 6 presents change masks 606 associated with the progressive time steps. Each change mask 606 indicates spatial regions where change occurs between the corresponding pre change tile and post change tile in the time series. In the illustrated example, the change masks 606 highlight the footprint and roof area of the evolving building, while leaving areas corresponding to trees, open spaces, and adjacent structures marked as unchanged. The change masks 606 confirm that the pipeline localizes change accurately and maintains temporal consistency across multiple time steps.

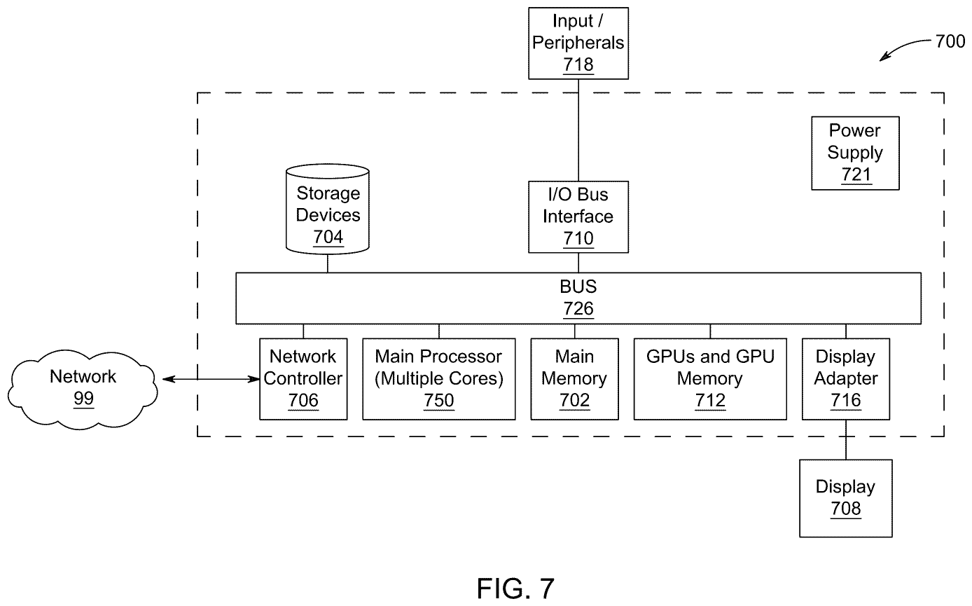

FIG. 7 illustrates an example hardware architecture of a computer-based artificial intelligence (AI) workstation 700 configured to implement the image processing, change simulation, and dataset generation operations described herein. The AI workstation 700 may be implemented as a standalone computing device, a desktop workstation, a server-class system, a distributed cluster node, or any other computing platform capable of executing neural-network- based functions on high resolution images.

The AI workstation 700 includes a bus 726 or other communication fabric configured to interconnect various hardware components. Coupled to the bus 726 is main memory 702, which may include volatile memory elements such as dynamic random-access memory (DRAM) used to store program instructions, intermediate tensors, activation maps, depth maps, semantic maps, change masks, and other data consumed by neural network modules.

The workstation 700 further includes one or more storage devices 704, such as solid-state drives (SSD), non-volatile memory express (NVMe) drives, magnetic storage, or other persistent memory technologies. These storage devices 704 may store high-resolution aerial and Earth satellite imagery, machine-learning models including depth map generation neural networks, semantic map creation models, change simulation modules, image diffusion models such as stable diffusion pipelines, classifier networks, ground-truth object databases, and image tile repositories.

A main processor 750, which may comprise a plurality of multi-core CPUs, application-specific integrated circuits (ASICs), or heterogeneous compute engines, is also coupled to the bus 726. In certain embodiments, the main processor 750 includes circuitry configured to cyclically perform fused multiply-add (FMA) operations, enabling accelerated neural-network computation. The processor cores may execute instructions for generating depth maps, creating semantic maps, determining candidate areas for change simulation, generating pre-change and post-change tiles, and performing quality assessment or validation operations as described with reference to the claims.

One or more GPUs and GPU memory 712 are also operatively coupled to the bus 726. The GPUs may provide massively parallel compute resources for training and inference operations in connection with deep-learning architectures. In some implementations, the GPU memory may store latent representations, intermediate results of diffusion-based image generation, or condition-based control network features used for guiding image synthesis. The GPU subsystem may operate cooperatively with the main processor 750 to perform operations attributed to the processing circuitry in Claims 1-20, including but not limited to depth map generation, semantic segmentation, change mask computation, inpainting operations for change incorporation, time series change simulation, and tile image generation via diffusion pipelines.

An I/O bus interface 710 is coupled to the bus 726 and connects to various peripheral devices. An input/peripheral interface 718 may include a keyboard, mouse, stylus, touchscreen, sensor input device, or other user input mechanism configured to receive user selections, including selection of a static image from a set of high-resolution aerial or Earth satellite images, and input of parameters such as a number of time steps for iterative tile generation.

A display adapter 716 is also connected to the bus 726 and drives a display 708, which may be used to present pre-change and post-change tiles, masks, validation scores, similarity assessments, and other outputs. In certain embodiments, the display 708 enables a user to validate pairs of change tiles and classify them as valid or invalid, consistent with the validation operations.

The AI workstation 700 further includes a network controller 706, which may support wired or wireless communication with an external network 99. The network controller 706 may facilitate downloading high-resolution satellite imagery, synchronizing object databases, or transmitting trained model parameters to remote storage. A power supply 721 provides operational power to the components of the workstation 700.

Although FIG. 7 depicts a particular arrangement of components, the AI workstation may include additional or fewer elements, distribute functionalities across different hardware layers, or implement the described modules in hardware, software, or a combination thereof. The illustrated components may also include specialized acceleration units for tensor computation, dedicated AI inference engines, digital signal processors, or programmable logic devices configured to perform the operations attributed to the processing circuitry.

In operation, the hardware components of FIG. 7 collectively support the functionality described herein, including (i) downloading high-resolution satellite images, (ii) generating depth maps and semantic maps, (iii) simulating changes with iterative determination of candidate regions, (iv) producing pairs of pre-change and post-change tiles using diffusion-based neural networks conditioned on change depth maps, (v) validating and storing generated tiles, and (vi) constructing datasets for change detection model training. The workstation architecture 700 thus provides a computational platform suitable for executing the method steps and for implementing the AI workstation.

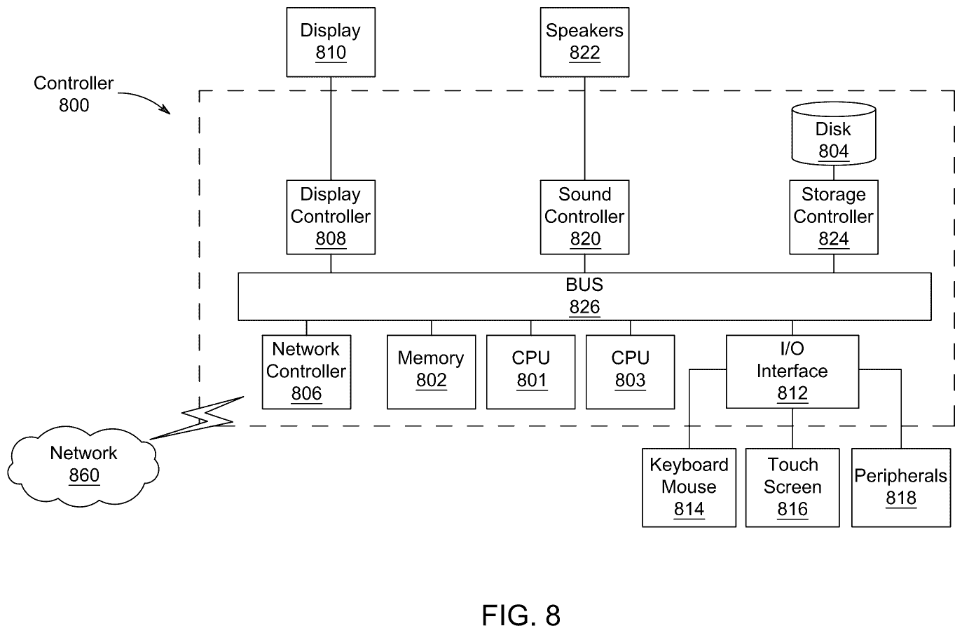

Next, further details of the hardware description of the computing environment according to exemplary embodiments is described with reference to FIG. 8. In FIG. 8, a controller 800 is described is representative of the system 110 of FIG. 1 in which the controller is a computing device which includes a CPU 801 which performs the processes described above/below. The process data and instructions may be stored in memory 802. These processes and instructions may also be stored on a storage medium disk 804 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 801, 803 and an operating system such as Microsoft Windows 8, Microsoft Windows 11, UNIX, LINUX, Apple MAC-OS and other systems known to those skilled in the art.

The hardware elements in order to achieve the computing device may be realized by various circuitry elements, known to those skilled in the art. For example, CPU 801 or CPU 803 may be a Xenon or Core processor from Intel of America or an Opteron processor from AMD of America, or may be other processor types that would be recognized by one of ordinary skill in the art. Alternatively, the CPU 801, 803 may be implemented on an FPGA, ASIC, PLD or using discrete logic circuits, as one of ordinary skill in the art would recognize. Further, CPU 801, 803 may be implemented as multiple processors cooperatively working in parallel to perform the instructions of the inventive processes described above.

The computing device in FIG. 8 also includes a network controller 806, such as an Intel Ethernet PRO network interface card from Intel Corporation of America, for interfacing with network 860. As can be appreciated, the network 860 can be a public network, such as the Internet, or a private network such as an LAN or WAN network, or any combination thereof and can also include PSTN or ISDN sub-networks. The network 860 can also be wired, such as an Ethernet network, or can be wireless such as a cellular network including EDGE, 3G, 4G, and 5G wireless cellular systems. The wireless network can also be WiFi, Bluetooth, or any other wireless form of communication that is known.

The computing device further includes a display controller 808, such as a NVIDIA GeForce RTX or Quadro graphics adaptor from NVIDIA Corporation of America for interfacing with display 810, such as a Hewlett Packard HPL2445w LCD monitor. A general purpose I/O interface 812 interfaces with a keyboard and/or mouse 814 as well as a touch screen panel 816 on or separate from display 810. General purpose I/O interface also connects to a variety of peripherals 818 including printers and scanners, such as an OfficeJet or DeskJet from Hewlett Packard.

A sound controller 820 is also provided in the computing device such as Sound Blaster X-Fi Titanium from Creative, to interface with speakers/microphone 822 thereby providing sounds and/or music.

The general purpose storage controller 824 connects the storage medium disk 804 with communication bus 826, which may be an ISA, EISA, VESA, PCI, or similar, for interconnecting all of the components of the computing device. A description of the general features and functionality of the display 810, keyboard and/or mouse 814, as well as the display controller 808, storage controller 824, network controller 806, sound controller 820, and general purpose I/O interface 812 is omitted herein for brevity as these features are known.

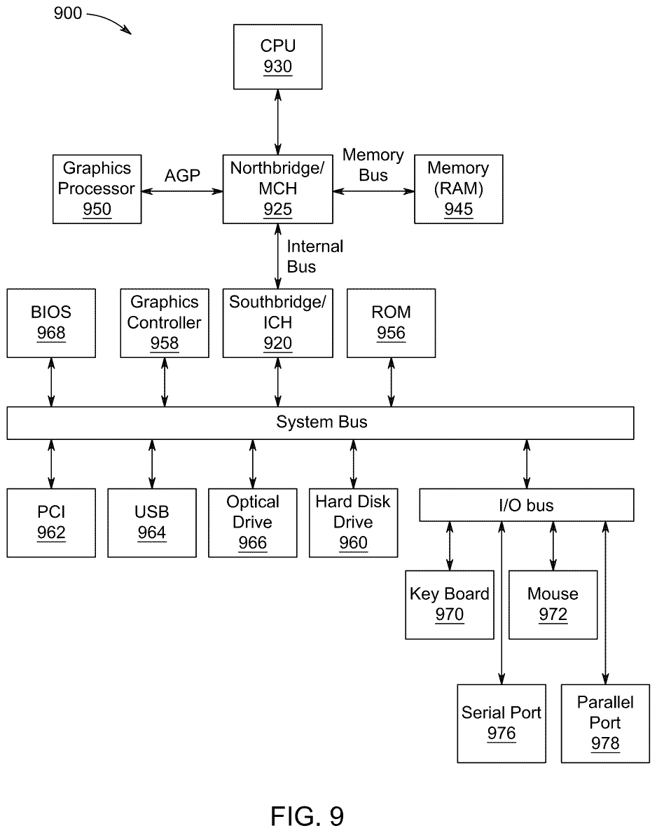

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 9.

FIG. 9 shows a schematic diagram of a data processing system, according to certain embodiments, for performing the functions of the exemplary embodiments. The data processing system is an example of a computer in which code or instructions implementing the processes of the illustrative embodiments may be located.

In FIG. 9, data processing system 900 employs a hub architecture including a north bridge and memory controller hub (NB/MCH) 925 and a south bridge and input/output (I/O) controller hub (SB/ICH) 920. The central processing unit (CPU) 930 is connected to NB/MCH 925. The NB/MCH 925 also connects to the memory 945 via a memory bus, and connects to the graphics processor 950 via an accelerated graphics port (AGP). The NB/MCH 925 also connects to the SB/ICH 920 via an internal bus (e.g., a unified media interface or a direct media interface). The CPU Processing unit 930 may contain one or more processors and even may be implemented using one or more heterogeneous processor systems.

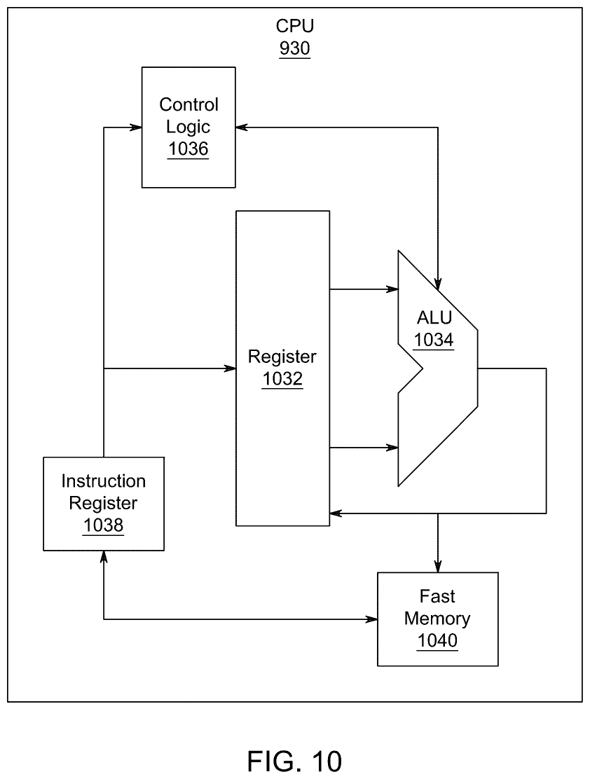

For example, FIG. 10 shows one implementation of CPU 930. In one implementation, the instruction register 1038 retrieves instructions from the fast memory 1040. At least part of these instructions is fetched from the instruction register 1038 by the control logic 1036 and interpreted according to the instruction set architecture of the CPU 930. Part of the instructions can also be directed to the register 1032. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using the arithmetic logic unit (ALU) 1034 that loads values from the register 1032 and performs logical and mathematical operations on the loaded values according to the instructions. The results from these operations can be feedback into the register and/or stored in the fast memory 1040. According to certain implementations, the instruction set architecture of the CPU 930 can use a reduced instruction set architecture, a complex instruction set architecture, a vector processor architecture, a very large instruction word architecture.

Furthermore, the CPU 930 can be based on the Von Neuman model or the Harvard model. The CPU 930 can be a digital signal processor, an FPGA, an ASIC, a PLA, a PLD, or a CPLD. Further, the CPU 930 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 9, the data processing system 900 can include that the SB/ICH 920 is coupled through a system bus to an I/O Bus, a read only memory (ROM) 956, universal serial bus (USB) port 964, a flash binary input/output system (BIOS) 968, and a graphics controller 958. PCI/PCIe devices can also be coupled to SB/ICH 988 through a PCI bus 962.

The PCI devices may include, for example, Ethernet adapters, add-in cards, and PC cards for notebook computers. The Hard disk drive 960 and CD-ROM 966 can use, for example, an integrated drive electronics (IDE) or serial advanced technology attachment (SATA) interface. In one implementation the I/O bus can include a super I/O (SIO) device.

Further, the hard disk drive (HDD) 960 and optical drive 966 can also be coupled to the SB/ICH 920 through a system bus. In one implementation, a keyboard 970, a mouse 972, a parallel port 978, and a serial port 976 can be connected to the system bus through the I/O bus. Other peripherals and devices that can be connected to the SB/ICH 920 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

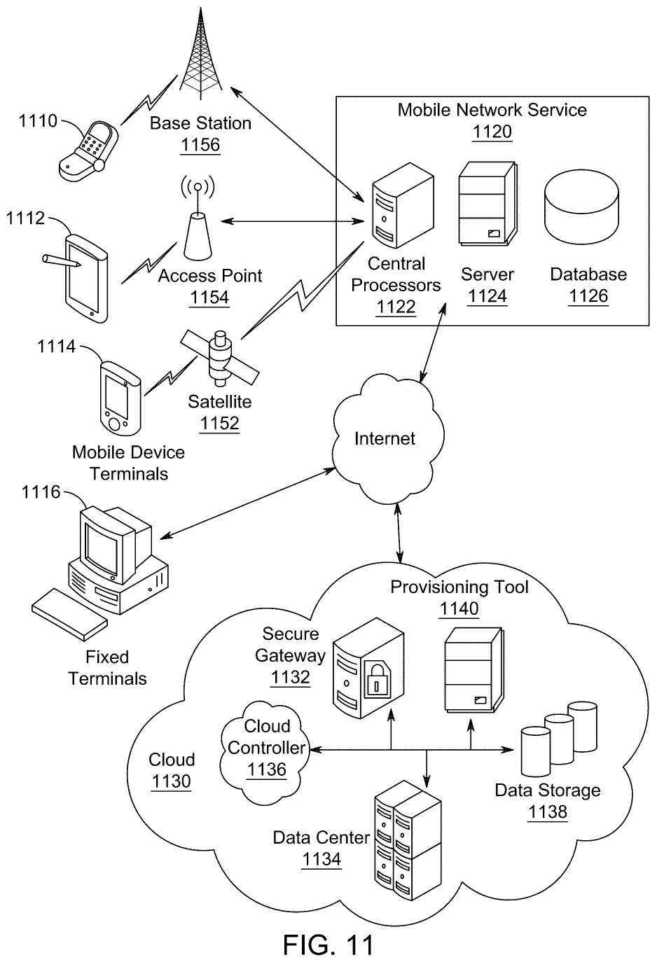

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 11, in addition to various human interface and communication devices (e.g., display monitors, smart phones, tablets, personal digital assistants (PDAs)). More specifically, FIG. 11 illustrates client devices including a smart phone 1101, a tablet 1102, a mobile device terminal 1104 and fixed terminals 1106. These client devices may be commutatively coupled with a mobile network service 1120 via a base station 1156, an access point 1154, a satellite 1152 or via an internet connection. The mobile network service 1120 may comprise central processors 1122, a server 1124 and a database 1126. The fixed terminals 1106 and the mobile network service 1120 may be commutatively coupled via an internet connection to functions in cloud 1130 that may comprise a security gateway 1132, a data center 1134, a cloud controller 1136, a data storage 1138 and a provisioning tool 1140. The network may be a private network, such as the LAN or the WAN, or may be the public network, such as the Internet. Input to the system may be received via direct user input and received remotely either in real-time or as a batch process.

Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A system for generating valid remote sensing change images, comprising:
a user input device for downloading aerial and Earth satellite images of high resolution or greater and selecting a static image from among the aerial and Earth satellite images, wherein the high resolution or greater is a pixel size of 0.3 m/pixel or less;
processing circuitry, comprising a plurality of multi-core processors for cyclically performing fused multiply-add (FMA) operations, configured to
generate, by a depth map generation neural network, an original depth map of the static image, where the depth map is an image that contains information relating to distance of surfaces of objects from a viewpoint,
create, by a semantic map creator, a semantic map of the static image, wherein the semantic map includes annotated objects in the static image,
generate, by a change simulator that iteratively determines a plurality of candidate areas for change simulation, a change depth map and a change mask, wherein the change mask focuses on one or more objects removed from the static image, and
generate, by an image diffusion neural network, a pair of change tiles and a mask using the change depth map, wherein the pair of change tiles includes a post-change tile and a pre-change tile;
validation processing circuitry configured to iteratively validate the pair of change tiles to obtain a validated pair of change tiles and a validated change mask,
wherein the validation includes comparing each object in the pair of change tiles to each of a plurality of ground truth objects,
wherein a change tile is invalid when the object is a distorted object or results in an impossible context such that the object does not substantially match any of the plurality of ground truth objects,
wherein when the pair of change tiles are found invalid, store an identifier to indicate that the pair of change tiles is invalid in a rejected list; and
a database configured to store the validated pair of change tiles and the validated mask.

2. The computer-based AI workstation of claim 1, wherein the user input is further configured for inputting a number of time steps to iteratively generate progressive pairs of change image tiles, and
wherein the processing circuitry is further configured to
repeat the steps for producing the pair of change tiles and the mask by taking a post-change tile of the pair of change tiles, produced at a current time step, as the input for generating the pre and post pair of change tiles and mask for a next time step, in accordance with the number of time steps.

3. The computer-based AI workstation of claim 1, wherein the processing circuitry is further configured to incorporate changes, by the change simulator, into a determined candidate area in the original depth map using image inpainting.

4. The computer-based AI workstation of claim 1, wherein the processing circuitry is further configured to generate, by the change simulator, a progressive pair of change tiles that modifies an object without modifying a surrounding scene of the static image.

5. The computer-based AI workstation of claim 1, wherein the processing circuitry is further configured to generate, by change simulator, a time series change without modifying a remaining scene of the static image.

6. The computer-based AI workstation of claim 1, wherein the processing circuitry is further configured to:
generate, by a stable diffusion pipeline that uses the change depth map as a reference image, the pair of change tiles from the original depth map, and
store the generated change pairs and the change mask in the database.

7. The computer-based AI workstation of claim 6, wherein the processing circuitry is further configured to guide, by the stable diffusion pipeline including an image generation model and a control network that incorporates change information, image generation in the image generation model to produce a pre-change tile and a post-change tile.

8. The computer-based AI workstation of claim 1, wherein the processing circuitry is further configured to perform, by a quality assessment module that uses each generated change object as a query, a search in an object database of ground truth objects; and when there is a similarity to any object in the object database of the ground truth objects, properly generate the object.

9. The computer-based AI workstation of claim 1, wherein the processing circuitry is further configured to:
apply a classifier network to detect when a generated change object belongs to a certain class, and determine a score associated with the classification; and
display the score to show a degree that the generated change object belongs to the certain class.

10. A method of training a remote sensing change detection model, the method comprising:
downloading, by a user input device, aerial and Earth satellite images of high resolution or greater, wherein the high resolution or greater is a pixel size of 0.3 m/pixel or less;
selecting, by the user input device, a static image from among the aerial and satellite images;
generating, by multi-core processors that cyclically perform fused multiply-add operations for a depth map generator, an original depth map of the static image, where the depth map is an image that contains information relating to distance of surfaces of objects from a viewpoint;
creating, by processing circuitry configured with a semantic map creator, a semantic map of the static image, wherein the semantic map includes annotated objects in the static image;
generating, by the processing circuitry configured with a change simulator that iteratively determines a candidate area for change simulation, a change depth map and a change mask, wherein the change mask focuses on one or more objects removed from the static image;
generating, by multi-core processors that cyclically perform fused multiply-add operations for a tile image generator, a pair of change tiles and a mask using the change depth map, wherein the pair of change tiles includes a post-change tile and a pre-change tile;
iteratively validating, by validation processing circuitry, the pair of change tiles and the mask to obtain a validated pair of change tiles and masks;
wherein the validating includes comparing each object in the pair of change tiles to each of a plurality of ground truth objects,
wherein a change tile is invalid when a object in the change tile is a distorted object or results in an impossible context such that the object does not substantially match any of the plurality of ground truth objects,
wherein when the pair of change tiles are found invalid, store an identifier to indicate that the pair of change tiles is invalid in a rejected list; and
training, by the multi-core processors, the remote sensing change detection model with a database of a plurality of validated pairs of change tiles and masks.

11. A non-transitory computer-readable storage medium including computer executable instructions, wherein the instructions, when executed by an AI workstation, cause the computer to perform a method for generating land use area change images, the method comprising:
downloading, by a user input device, aerial and Earth satellite images of high resolution or greater, wherein the high resolution or greater is a pixel size of 0.3 m/pixel or less;
selecting, by the user input device, a static image from among the aerial and satellite images;
generating, by multi-core processors that cyclically perform fused multiply-add operations for a depth map generator, an original depth map of the static image, where the depth map is an image that contains information relating to distance of surfaces of objects from a viewpoint;
creating, by processing circuitry configured with a semantic map creator, a semantic map of the static image, wherein the semantic map includes annotated objects in the static image;
generating, by the processing circuitry configured with a change simulator that iteratively determines a candidate area for change simulation, a change depth map and a change mask, wherein the change mask focuses on one or more objects removed from the static image;
generating, by multi-core processors that cyclically perform fused multiply-add operations for a tile image generator, a pair of change tiles and a mask using the change depth map, wherein the pair of change tiles includes a post-change tile and a pre-change tile;
iteratively validating, by validation processing circuitry, the pair of change tiles and the mask to obtain a validated pair of change tiles and a validated change mask,
wherein the validating includes comparing each object in the pair of change tiles to a plurality of ground truth objects,
wherein a change tile is invalid when a object for the change tile is a distorted object or results in an impossible context such that the object does not substantially match any of the plurality of ground truth objects,
wherein when the pair of change tiles are found invalid, store an identifier to indicate that the pair of change tiles is invalid in a rejected list; and
storing the validated pair of change tiles and the validated mask in a database.

12. The computer-readable storage medium of claim 11, further comprising:
inputting, by the user input, a number of time steps to iteratively generate progressive pairs of change image tiles; and
repeating, by the processing circuitry, the steps for producing the pair of change tiles and the mask by taking a post-change tile of the pair of change tiles, produced at a current time step, as the input for generating the pre and post pair of change tiles and mask for a next time step, in accordance with the number of time steps.

13. The computer-readable storage medium of claim 11, further comprising incorporating, by the change simulator, changes into a determined candidate area in the original depth map using image inpainting.

14. The computer-readable storage medium of claim 11, further comprising generating, by the change simulator, a progressive pair of change tiles that modifies an object without modifying a surrounding scene of the static image.

15. The computer-readable storage medium of claim 11, further comprising generating, by the change simulator, a time series change without modifying a remaining scene of the static image.

16. The computer-readable storage medium of claim 11, further comprising:
generating, by a stable diffusion pipeline that uses the change depth map as a reference image, the pair of change tiles; and
storing the generated change pairs and the changed mask in the database.

17. The computer-readable storage medium of claim 16, further comprising
guiding, by the stable diffusion pipeline including an image generation model and a condition-based control neural network that incorporates change information, image generation in the image generation model to produce a pre-change tile and a post-change tile.

18. The computer-readable storage medium of claim 17, further comprising
guiding, by the condition-based control neural network, image generation with a prompt for style of each image,
wherein the prompt is a textual prompt: “Generate Satellite image using {CITY_NAME} style”.

19. The computer-readable storage medium of claim 11, further comprising performing, by a quality assessment module that uses each generated change object as a query, a search in a database of the ground truth objects; and when there is a similarity to any object in the database of ground truth objects, properly generating the object.

20. The computer-readable storage medium of claim 11, further comprising:
applying a classifier neural network to detect if a generated change object belongs to a certain class;
determining a score associated with the classification; and
displaying the score to show a degree that the generated change object belongs to the certain class.
